(19) United States
(12) Patent Application Publication
(10) Pub. No.: US 2005/0019660 A1
(43) Pub. Date: Jan. 27, 2005

(54) Non-aqueous electrolyte battery

(76) Inventors: Keizo Koga, Fukushima (JP); Atsuo Omaru, Fukushima (JP)

Correspondence Address: ROBERT J. DEPKE LEWIS T. STEADMAN;HOLLAND & KNIGHT LLC, 131 SOUTH DEARBORN, 30TH FLOOR, CHICAGO, IL, 60603, US

(21) Appl. No.: 10/875,129

(22) Filed: Jun. 23, 2004

(30) Foreign Application Priority Data
Jul. 1, 2003 (JP) JP2003-189702

(51) Int. Cl. H01M 4/58

(52) U.S. Cl. 429/231.8

(57) ABSTRACT

A non-aqueous electrolyte battery includes a cathode, an anode and a non-aqueous electrolyte. The anode uses as an anode active material graphite whose Gs value obtained by a formula (1) from a surface-enhanced Raman spectrum measured by using an argon laser beam is 20 or smaller.
Gs=Hsg/Hsd (1)
(Here, Hsg represents the height of a signal having a peak within a range of 1580 cm⁻¹ to 1620 cm⁻¹ and Hsd represents the height of a signal having a peak within a range of 1350 cm⁻¹ to 1400 cm⁻¹.) Thus, the high capacity, the high filling characteristics and the low temperature load characteristics of an anode material are improved.

### BACKGROUND OF THE INVENTION

1. Field of the Invention

The present invention relates to a non-aqueous electrolyte battery in which the high capacity, the filling characteristics and the low temperature load characteristics of an anode active material are improved.

This application claims priority of Japanese Patent Application No. 2003-189702, filed on Jul. 1, 2003, the entirety of which is incorporated by reference herein.

2. Description of the Related Art

In recent years, as electronic devices are progressively miniaturized and portable, light lithium-ion secondary batteries high in their energy density have been paid attention to as driving power sources thereof. As anode active materials thereof, carbon materials, lithium metals, lithium alloys, etc. have been well-known. Among them, the carbon materials capable of adsorbing and/or desorbing lithium have a high charging and discharging reversibility and high Coulomb efficiency and hardly produce the dendrite of lithium, so that the carbon materials are very promising as the anode materials. The anode material is combined with a cathode composed of lithium containing composite oxide, so that the obtained product is brought to market. Further, with the progress of the miniaturization and multi-functions of the electronic devices, a request for the high capacity and long life of the lithium-ion secondary batteries has been increased.

Japanese Patent Application Laid-Open No. 2002-8655 discloses a non-aqueous electrolyte battery that uses an anode active material including at least one or more kinds of carbon materials between flake graphite, spherical graphite, massive graphite, fibrous graphite, non-graphitizable carbon or carbon black to have a high capacity and high cyclic characteristics and high volumetric energy density even in the discharge of a large quantity of electric current.

Further, Japanese Patent Application Laid-Open No. 2001-283844 discloses a non-aqueous electrolyte battery that employs graphite in which the peak intensity ratio of a (002) plane to a (110) plane by a powder x-ray diffraction method using a Cu-Kα ray source is regulated to a value not larger than 1000 as an anode active material to improve a bulk density.

However, the miniaturization and multi-functions of the electronic devices have outstandingly progressed. In accordance therewith, demands for the lithium-ion secondary batteries have been increased too greatly to adequately satisfy them.

### SUMMARY OF THE INVENTION

The present invention is proposed by considering the above-described circumstances and it is an object of the present invention to provide a non-aqueous electrolyte battery in which the high capacity, the high filling characteristics and the low temperature load characteristics of an anode active material are improved.

In order to achieve the above-described object, a non-aqueous electrolyte battery according to the present invention comprises a cathode, an anode and a non-aqueous electrolyte. The anode uses as an anode active material graphite whose Gs value obtained by a formula (1) from a surface-enhanced Raman spectrum measured by using an argon laser beam is 20 or smaller.
Gs=Hsg/Hsd (1)

Here, Hsg represents the height of a signal having a peak within a range of 1580 cm⁻¹ to 1620 cm⁻¹ and Hsd represents the height of a signal having a peak within a range of 1350 cm⁻¹ to 1400 cm⁻¹.

In the above-described non-aqueous electrolyte battery according to the present invention, the Gs value of the graphite serving as the anode active material is specified so that an electronic conductivity can be controlled to greatly reduce an irreversible capacity upon initial charging operation.

### BRIEF DESCRIPTION OF THE DRAWING

FIG. 1 is a longitudinally sectional view showing one structural example of a non-aqueous electrolyte battery according to the present invention.

### DETAILED DESCRIPTION OF THE PREFERRED EMBODIMENT

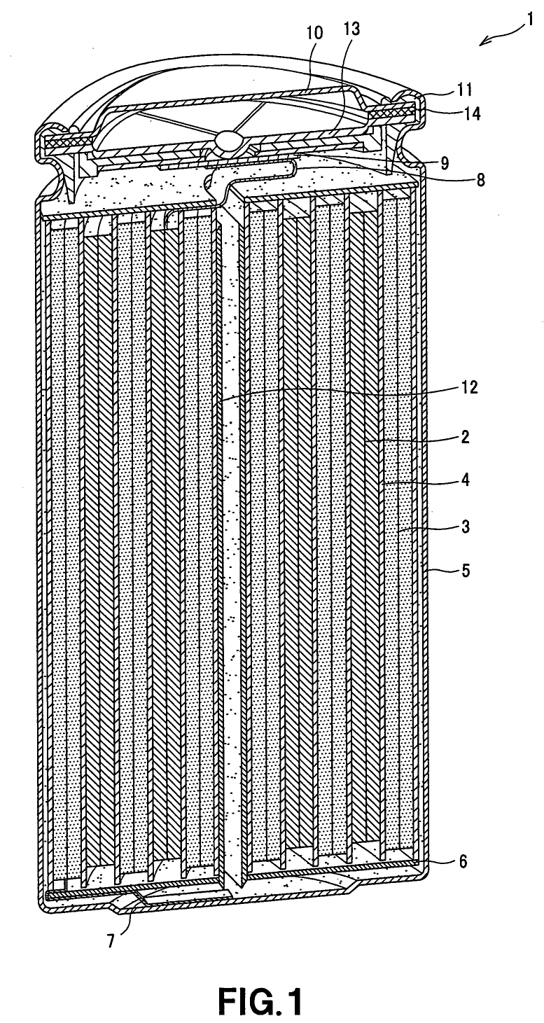

Now, a preferred embodiment of a non-aqueous electrolyte battery to which the present invention is applied will be described by referring to the drawing. FIG. 1 is a longitudinally sectional view showing one structural example of a non-aqueous electrolyte battery according to the present invention. In the non-aqueous electrolyte battery 1, a battery can 5 is filled with a spirally coiled body formed by coiling a film type cathode 2 and a film type anode 3 through a separator 4 in a tight contact state.

The cathode 2 is formed by applying and drying a cathode composite mixture including a cathode active material and a binding agent on a current collector. As the current collector, for instance, a metallic foil such as an aluminum foil is used.

As the cathode active materials, metal oxides, metal sulfides, or specific polymers may be used depending on kinds of desired batteries.

As the cathode active materials, for instance, lithium composite oxides including LiMₓO₂ as a main component (in the formula, M represents one or more kinds of transition metals, x represents the number of valences of M and is different depending on the charging or discharging state of the battery and ordinarily 0.05 or larger and 1.10 or smaller.) or the like may be used. As the transition metals M forming the lithium composite oxides, Co, Ni, Mn, etc. are preferable. As specific examples of the lithium composite oxides, LiCoO₂, LiNiO₂, LiNi_{y}CO_{1-y}O₂ (in the formula, y represents the number of valences of Ni and is larger than 0 and smaller than 1. ), LiMn₂O₄, etc. may be exemplified. These lithium composite oxides can generate high voltage and become cathode active materials excellent in their energy density. For the cathode 2, a plurality of kinds of the cathode active materials may be combined together and the combined product may be used.

As the binding agent of the cathode composite mixture, a well-known binding agent ordinarily used in the cathode composite mixture of the battery can be employed. In addition thereto, a well-known addition agent such as a conductive agent may be added to the cathode composite mixture.

The anode 3 is formed by applying and drying an anode composite mixture including an anode active material and a binding agent on a current collector. As the current collector, for instance, a metallic foil such as a copper foil is used.

In the lithium-ion battery according to the present invention, graphite having below-described material parameters is used as the anode active material. The inventors of the present invention eagerly studied. As a result, they hit on the idea that the surface material parameters of graphite particles were specified as described below so that a surface electronic structure and an electronic conductivity could be controlled. Thus, they finally realized a graphite material for an anode that could exhibit high load characteristics at low temperature.

That is, in the present invention, a Gs value obtained by a below-described formula (1) from a surface-enhanced Raman spectrum measured by using an argon laser beam is set to 20 or smaller. The Gs value of the graphite is set to 20 or smaller so that an irreversible capacity during an initial charging operation can be greatly reduced.
Gs=Hsg/Hsd (1)

Here, Hsg represents the height of a signal having a peak within a range of 1580cm⁻¹ to 1620 cm⁻¹ and Hsd represents the height of a signal having a peak within a range of 1350 cm⁻¹ to 1400 cm⁻¹.

Now, a method for measuring the material parameter Gs will be described below. The material parameter Gs used in the present invention is measured by the surface-enhanced Raman spectroscopy method to which a Raman spectroscopy method is applied. The surface-enhanced Raman spectroscopy method is a method for measuring Gs by forming a metallic thin film such as silver, gold, etc. on the surface of a sample, which was invented by Fleischmann et al. in 1974. A measurement can be carried out on metallic sol particles as well as solid metal.

In this specification, silver was deposited on the surface of a sample and the material parameter Gs was measured by a Raman spectroscope having a wave number resolution of 4 cm⁻¹ by using an argon laser beam with the wavelength of 514.5 nm.

A peak (Psg) appearing in the vicinity of a range of 1580 cm⁻¹ to 1620 cm⁻¹ shows an oscillation mode originating from a graphite crystalline structure. A peak (Psd) appearing in the vicinity of a range of 1350 cm⁻¹ to 1400 cm⁻¹ shows an oscillation mode originating from an amorphous turbostratic structure.

Then, the ratio of the intensity (the height Hsg) of Psg to the intensity (the height Hsd) of Psd, that is, the material parameter Gs represents a degree of graphitization of a surface. As amorphous parts on the surface part are increased, that is, Hsd becomes large, the Gs value becomes small. When the amorphous parts are increased on the surfaces of the graphite particles, the particles are hardened and hardly collapse. However, when the amorphous parts are too increased on the surfaces of the particles, a surface resistance is undesirably increased.

Thus, in the present invention, the Gs value of the graphite is set to 20 or smaller. When the Gs value is set to 20 or smaller, the rate of the amorphous parts on the surfaces of the graphite particles can be optimized and a suitable hardness can be made compatible with the surface resistance. Thus, the irreversible capacity during the initial charging operation can be greatly reduced. The Gs value is more preferably located within a range of 3 or larger and 10 or smaller.

Further, the inventors of the present invention hit on the idea that the true specific gravity of graphite was specified as well as the surface electronic structure of the graphite particles so that a high reversible capacity could be realized. That is, the true specific gravity of the graphite is preferably 2.20 g/cm³ or higher. When the true specific gravity of the graphite is set to 2.20 g/cm³ or higher, the high reversible capacity during charging and discharging operations can be realized. The true specific gravity of the graphite is more preferably located within a range of 2.24 g/cm³ or higher and 2.256 g/cm³ or lower. In the specification, the true specific gravity of the graphite was measured by a true density analyzer Auto True Denser: MAT5000 (produced by Seishin Enterprise Co., Ltd.).

Further, the inventors of the present invention hit upon the idea that the filling characteristics of the active material per prescribed volume were specified to exhibit a high discharging capacity and reduce a contact resistance in the battery so that the battery excellent in its load characteristics at low temperature could be realized.

Specifically, the graphite was pressed and formed by a pellet making device to measure the density of the pellets. The density shows an index for measuring the flexibility of the graphite particles. In a measurement, a sample of the graphite particles of 0.25 g was weighed into a pellet making device having the diameter of the pellet of 13 mm and pressed under 5 tf/cm² to form a compact and calculate the density thereof.

The density of the pellet is preferably 1.70 g/cm³ or higher. The graphite particles are pressed so that the particles are deformed to fill gaps between the particles with the deformed parts. Thus, contact points between the graphite particles are increased in the pellet to reduce a resistance. That is, the density of the pellet of the graphite is set to 1.70 g/cm³ or higher to increase the contact points between the particles and reduce an electric resistance. Accordingly, the high discharging capacity can be exhibited. The density of the pellet is more preferably located within a range of 1.70 g/cm³ or higher and 2.25 g/cm³ or lower. When the density of the pellet is lower than 1.70 g/cm³, the above-described operational effect can be hardly obtained. On the other hand, when the density of the pellet is 2.25 g/cm³ or higher, for instance, spaces for storing non-aqueous electrolyte solution in the pellet may be possibly decreased to increase the electric resistance and deteriorate battery characteristics.

The surface resistance of the pellet obtained by pressing and molding the graphite in the same manner as described above is preferably 50 Ω/cm or lower. When the surface resistance of the pellet is set to 50 Ω/cm or lower, the contact resistance in the battery can be reduced and the battery excellent in its load characteristics at the low temperature can be realized. The surface resistance of the pellet is measured by a four terminal resistance measuring device.

In the present invention, the graphite having the above-described parameters is employed as the anode active material. As the binding agent of the anode composite mixture, a well-known binding agent ordinarily used for the anode composite mixture of the lithium-ion battery can be used. In addition thereto, a well-known addition agent or the like can be added to the anode composite mixture.

The non-aqueous electrolyte solution is prepared by dissolving electrolyte salt in a non-aqueous solvent. As the electrolyte salts, well-known electrolyte salts generally used in the battery electrolyte solution can be used. Specifically, lithium salts such as LiPF₆, LiBF₄, LiAsF₆, LiClO₄, LiCF₃SO₃, LiN(SO₂CF₃)₂, LiC(SO₂CF₃)₃, LiAlCl₄, LiSiF₆, etc. may be exemplified. Among them, LiPF₆ and LiBF₄ are especially desirable in view of the oxidation stability.

These electrolyte salts are preferably dissolved in the non-aqueous solvent in the concentration of 0.1 mol/liter to 3.0 mol/liter. Further, the electrolyte salts are more preferably dissolved in the concentration of 0.5 mol/liter to 2.0 mol/liter.

Further, as the non-aqueous solvents, various kinds of non-aqueous solvents usually employed for the non-aqueous electrolyte solution can be used. For instance, cyclic carbonic esters such as propylene carbonate, ethylene carbonate, etc.; chain carbonic esters such as diethyl carbonate, dimethyl carbonate, etc.; carboxylic esters such as methyl propionate or methyl butyrate, etc.; ethers such as γ-butyrolactone, sulfolane, 2-methyl tetrahydrofuran, dimethoxyethane, etc. may be employed. These non-aqueous solvents may be individually used or a plurality of kinds of non-aqueous solvents may be mixed together and the mixture may be used. Among them, the carbonic esters are especially preferably used in view of the oxidation stability.

The above-described cathode 2 and the anode 3 are spirally coiled many times in a tight contact state through the separator 4 to form a spirally coiled body. An insulating plate 6 is disposed on a bottom part of the battery can 5 made of iron an inner part of which is plated with nickel and the above-described spirally coiled body is accommodated on the insulating plate 6.

Then, one end of an anode lead 7 made of, for instance, nickel to collect the electric current of the anode 3 is connected to the anode 3. The other end is welded to the battery can 5. Thus, the battery can 5 is electrically conducted to the anode 3 to serve as an external anode of the non-aqueous electrolyte battery 1.

Further, one end of a cathode lead 8 made of, for instance, aluminum to collect the electric current of the cathode 2 is attached to the cathode 2. The other end is electrically connected to a battery cover 10 through a current interrupting thin plate 9. This current interrupting thin plate 9 interrupts an electric current in accordance with the internal pressure of the battery. Thus, the battery cover 10 is electrically conducted to the cathode 2 to serve as an external cathode of the non-aqueous electrolyte battery 1.

The non-aqueous electrolyte solution is injected to the battery can 5 to impregnate the spirally coiled body therewith. Then, the battery can 5 is caulked through an insulating sealing gasket 11 to which asphalt is applied. Thus, the battery cover 10 is fixed to the battery can.

In the non-aqueous electrolyte battery 1, as shown in FIG. 1, a center pin 12 serving as a coiling core, for instance, upon coiling, is provided at a substantially central part of the spirally coiled body. Further, a safety valve device 13 for purging gas in an inner part when pressure in the battery is higher than a prescribed value and a PTC element 14 for preventing the rise of temperature in the battery are provided in the vicinity of the battery cover 10.

In the non-aqueous electrolyte battery 1 obtained as described above, the material parameters of the graphite are specified to greatly reduce the irreversible capacity during the initial charging operation and obtain the high reversible capacity. Thus, the non-aqueous electrolyte battery 1 can exhibit the high discharging capacity and is excellent in its load characteristics at low temperature.

In the above-described embodiment, the non-aqueous electrolyte battery using the non-aqueous electrolyte solution is explained as an example, however, the present invention is not limited thereto. The present invention may be applied to a solid electrolyte battery that uses a solid polymer electrolyte including the single material or the mixture of conductive polymer compounds or a gel electrolyte battery using a solid gel electrolyte including a swelling solvent.

As the solid electrolytes, both a solid inorganic electrolyte and the solid polymer electrolyte which are materials having lithium ion conductivity may be employed. As the solid inorganic electrolytes, lithium nitride, lithium iodide, etc. may be exemplified. The solid polymer electrolyte includes electrolyte salt and polymer compound for dissolving it. As the polymer compounds, ether polymers such as poly (ethylene oxide) or bridged materials thereof, poly (methacrylate) esters, acrylates, etc. may be independently used or copolymerized in molecules or mixed together and the obtained products may be employed.

As the matrixes of the gel electrolytes, various kinds of polymers that absorb the non-aqueous electrolyte solution to gel may be employed. For instance, fluorinated polymers such as poly (vinylidene fluoride) or poly (vinylidene fluoride-co-hexafluoropropylene), etc., ether polymers such as poly (ethylene oxide) or bridged materials thereof, poly (acrylonitrile), etc. can be used. Especially, the fluorinated polymers are desirably used from the viewpoint of the oxidation-reduction stability. The electrolyte salts are included in the polymers to realize the ion conductivity.

Further, in the above-described embodiment, the secondary battery is explained as an example. However, the present invention is not limited thereto. The present invention may be applied to a primary battery. Further, the form of the battery of the present invention is not limited to a special configuration such as a cylindrical shape, a prismatic shape, a coin shape, a button shape, or the like. Still further, various kinds of sizes such as a thin type, a large type, etc. can be realized.

### EXAMPLES

Now, examples carried out to recognize the effects of the present invention are described. It is to be understood that the present invention is not limited to these examples.

<Sample 1>

Graphite powder was obtained as described below. Firstly, coal pitch was added to and mixed with petroleum pitch coke. Then, the mixture was pressed and molded at 150° C. Then, the obtained product was heat-treated in an inactive atmosphere at 300° C. and the temperature was further raised to 700° C. Then, the obtained product was pulverized, classified and heat-treated in the inactive atmosphere at 1000° C. to obtain a graphite precursor. The graphite precursor was heat-treated for one hour in the inactive atmosphere at 2800° C. to obtain the graphite powder.

As for the graphite powder obtained in such a way, the measurement of a pellet molding density, the measurement of a true specific gravity and a Raman spectroscopic measurement were carried out. Then, a cylindrical battery was formed in accordance with a below-described method to measure load characteristics at low temperature or the like.

An anode was formed in such a way as described below. The graphite powder of 90 parts by weight that was obtained as described above was mixed with polyvinylidene fluoride (PVDF) of 10 parts by weight as a binding agent to prepare an anode composite mixture. The anode composite mixture was dispersed in N-methyl pyrrolidone as a solvent to obtain slurry (paste state). An elongated copper foil having the thickness of 10 μm was used as an anode current collector. The anode composite mixture was applied to both the surfaces of the current collector, dried and then compression-molded to form the elongated anode.

A cathode was formed in such a way as described below. Firstly, lithium carbonate of 0.5 mol was mixed with cobalt carbonate of 1 mol. The obtained mixture was sintered for 5 hours in air at 900° C. to obtain LiCoO₂. LiCoO₂ of 91 parts by weight as a cathode active material, graphite of 6 parts by weight as a conductive agent and polyvinylidene fluoride of 3 parts by weight as a binding agent were mixed together to obtain a cathode composite mixture. The cathode composite mixture was dispersed in N-methyl pyrrolidone to have slurry (paste state). An elongated aluminum foil having the thickness of 20 μm was used as a cathode current collector. The cathode composite mixture slurry was uniformly applied to both the surfaces of the current collector, dried and then compression-molded to form the elongated cathode.

The elongated anode, the elongated cathode and a separator made of micro-porous polypropylene film having the thickness of 25 μm were laminated in order of the anode, the separator, the cathode and the separator to obtain a laminated body. The laminated body was spirally coiled many times to have a spirally coiled form. A final end part of the separator in an outermost peripheral part was fixed by a tape to form a coil type battery element.

The coil type battery element formed as described above was, as shown in FIG. 1, accommodated in a battery can (inside diameter of 17.38 mm, the thickness of the can of 0.31 mm) made of iron and plated with nickel that had the diameter of 18 mm and the height of 65 mm. On both the upper and lower surface of the coil type battery element, insulating plates were disposed. A cathode lead made of aluminum was drawn from the cathode current collector and welded to a battery cover. An anode lead made of nickel was drawn from the anode current collector and welded to the battery can. Into the battery can, electrolyte solution obtained by dissolving LiPF₆ at the rate of 1 mol/liter in a mixed solvent obtained by mixing propylene carbonate (refer it to as PC, hereinafter), ethylene carbonate (refer it to as EC, hereinafter) and dimethyl carbonate (refer it to as DMC, hereinafter) in a volume ratio of 1:2:2 was injected.

The battery can was caulked through an insulating sealing gasket having a surface to which asphalt was applied to fix the battery cover and hold the air-tightness of the battery. A cylindrical type non-aqueous electrolyte secondary battery having the above-described structure was manufactured. In the below-described explanation, for convenience sake, the cylindrical type non-aqueous electrolyte secondary battery is simply referred to as a battery.

<Sample 2>

When the graphite powder was obtained, the graphite powder was obtained in the same manner as that of the Sample 1 except that the graphite precursor was heat-treated for one hour in the inactive atmosphere at 2850° C. Then, the battery was formed in the same manner as that of the Sample 1 by using the graphite powder.

<Sample 3>

When the graphite powder was obtained, the graphite powder was obtained in the same manner as that of the Sample 1 except that the graphite precursor was heat-treated for one hour in the inactive atmosphere at 2900° C. Then, the battery was formed in the same manner as that of the Sample 1 by using the graphite powder.

<Sample 4>

When the graphite powder was obtained, the graphite powder was obtained in the same manner as that of the Sample 1 except that the graphite precursor was heat-treated for one hour in the inactive atmosphere at 2950° C. Then, the battery was formed in the same manner as that of the Sample 1 by using the graphite powder.

<Sample 5>

When the graphite powder was obtained, the graphite powder was obtained in the same manner as that of the Sample 1 except that the graphite precursor was heat-treated for one hour in the inactive atmosphere at 3000° C. Then, the battery was formed in the same manner as that of the Sample 1 by using the graphite powder.

<Sample 6>

When the graphite powder was obtained, the graphite powder was obtained in the same manner as that of the Sample 1 except that the graphite precursor was heat-treated for one hour in the inactive atmosphere at 3050° C. Then, the battery was formed in the same manner as that of the Sample 1 by using the graphite powder.

<Sample 7>

When the graphite powder was obtained, the graphite powder was obtained in the same manner as that of the Sample 1 except that the graphite precursor was heat-treated for one hour in the inactive atmosphere at 3100° C. Then, the battery was formed in the same manner as that of the Sample 1 by using the graphite powder.

<Sample 8>

When the graphite powder was obtained, the graphite powder was obtained in the same manner as that of the Sample 1 except that the graphite precursor was heat-treated for one hour in the inactive atmosphere at 3150° C. Then, the battery was formed in the same manner as that of the Sample 1 by using the graphite powder.

<Sample 9>

When the graphite powder was obtained, the graphite powder was obtained in the same manner as that of the Sample 1 except that the graphite precursor was heat-treated for one hour in the inactive atmosphere at 3200° C. Then, the battery was formed in the same manner as that of the Sample 1 by using the graphite powder.

<Sample 10>

When the graphite powder was obtained, the graphite powder was obtained in the same manner as that of the Sample 5 except that the coal pitch three times as much as the Sample 1 was added to the petroleum pitch coke. Then, the battery was formed in the same manner as that of the Sample 5 by using the graphite powder.

<Sample 11>

When the graphite powder was obtained, the graphite powder was obtained in the same manner as that of the Sample 5 except that the coal pitch two times as much as the Sample 1 was added to the petroleum pitch coke. Then, the battery was formed in the same manner as that of the Sample 5 by using the graphite powder.

<Sample 12>

When the graphite powder was obtained, the graphite powder was obtained in the same manner as that of the Sample 5 except that the coal pitch 1.6 times as much as the Sample 1 was added to the petroleum pitch coke. Then, the battery was formed in the same manner as that of the Sample 5 by using the graphite powder.

<Sample 13>

When the graphite powder was obtained, the graphite powder was obtained in the same manner as that of the Sample 5 except that the coal pitch 1.3 times as much as the Sample 1 was added to the petroleum pitch coke. Then, the battery was formed in the same manner as that of the Sample 5 by using the graphite powder.

<Sample 14>

When the graphite powder was obtained, the graphite powder was obtained in the same manner as that of the Sample 5 except that the coal pitch 0.8 times as much as the Sample 1 was added to the petroleum pitch coke. Then, the battery was formed in the same manner as that of the Sample 5 by using the graphite powder.

<Sample 15>

When the graphite powder was obtained, the graphite powder was obtained in the same manner as that of the Sample 5 except that the coal pitch 0.5 times as much as the Sample 1 was added to the petroleum pitch coke. Then, the battery was formed in the same manner as that of the Sample 5 by using the graphite powder.

<Sample 16>

When the graphite powder was obtained, the graphite powder was obtained in the same manner as that of the Sample 5 except that the coal pitch 0.3 times as much as the Sample 1 was added to the petroleum pitch coke. Then, the battery was formed in the same manner as that of the Sample 5 by using the graphite powder.

<Sample 17>

When the graphite powder was obtained, the graphite powder was obtained in the same manner as that of the Sample 5 except that the coal pitch 0.2 times as much as the Sample 1 was added to the petroleum pitch coke. Then, the battery was formed in the same manner as that of the Sample 5 by using the graphite powder.

<Sample 18>

When the graphite powder was obtained, the graphite powder was obtained in the same manner as that of the Sample 5 except that the coal pitch 0.1 times as much as the Sample 1 was added to the petroleum pitch coke.

<Sample 19>

When the graphite powder was obtained, the graphite powder was obtained in the same manner as that of the Sample 5 except that the coal pitch was not added to the petroleum pitch coke. Then, the battery was formed in the same manner as that of the Sample 5 by using the graphite powder.

(Evaluation)

For the graphite powder obtained in such a manner as described, the measurement of pellet molding density, the measurement of true specific gravity and the Raman spectroscopic measurement were carried out. Further, the charging and discharging test of the battery was performed to evaluate a discharging capacity, a capacity loss, a charging and discharging efficiency, battery capacity and load characteristics at low temperature.

In the Raman spectroscopic measurement was performed in such a way that silver of 10 nm was deposited on the surface of a sample to measure the material parameter Gs by a Raman spectroscope having a wave number resolution of 4 cm⁻¹ by using an argon laser beam with the wavelength of 514.5 nm.

The density of pellets was measured in such a way that a sample of the graphite particles of 0.25 g was weighed into a pellet making device having the diameter of the pellet of 13 mm and pressed under 5 tf/cm² to form a compact and calculate the density thereof.

As for the surface resistance of the pellet, the surface resistance of the pellet pressed and formed as described above was measured by a four terminal resistance measuring device.

The true specific gravity of the graphite was measured by a true density analyzer Auto True Denser: MAT5000 (produced by Seishin Enterprise Co., Ltd.)

<Method for Measuring Discharging Capacity, Capacity Loss, and Charging and Discharging Efficiency>

Further, the discharging capacity, the capacity loss and the charging and discharging efficiency of each Sample were measured as described below.

The discharging capacity and the capacity loss of the graphite powder in each Sample were measured by forming a test cell for measuring them. When the test cell was formed, a pre-heat treatment was firstly applied to the graphite powder of each Sample under conditions of temperature rise speed of about 30° C./minute, achievable temperature of 600° C. and achievable temperature holding time of one hour in an argon atmosphere. This pre-heat treatment was carried out immediately before an anode mixture making process as described below. Then, the graphite powder of 90 wt % to which the pre-heat treatment was carried out and PVDF of 10 wt % serving as a binder were mixed with dimethyl formamide as a solvent. The obtained mixture was dried to form an anode mixture. Then, the anode mixture of 37 mg was weighed, pressed and formed together with an Ni mesh to form a working electrode in the shape of a pellet having the diameter of 15.5 mm. After that, lithium metal was used for an opposed electrode and the opposed electrode and the working electrode were laminated through a separator made of a polypropylene porous film between the opposed electrode and the working electrode. The opposed electrode and the working electrode which were laminated through the separator were sealed together with electrolyte solution obtained by dissolving LiPF₆ at the rate of 1 mol/liter in a mixed solvent obtained by mixing PC, EC and DMC in the ratio of 1:1:1 in an outer package can having the diameter of 20 mm and the thickness of 2.5 mm. Thus, a coin type test cell was formed.

Then, when the test cell formed in such a way was used to measure the discharging capacity and the capacity loss, the measurement was carried out under below-described conditions. In this measurement, when the graphite powder is doped with and/or dedoped from lithium, not a charging operation, but a discharging operation is carried out in a process that the graphite powder is doped with lithium, and not a discharging operation, but a charging operation is carried out in a process that the graphite powder is dedoped from lithium. Here, however, for convenience sake, the charging and discharging operations are carried out to meet the actual states of an actual battery. Namely, here, the process that the graphite powder is doped with lithium is called a charging process and the process that the graphite powder is dedoped from lithium is called a discharging process.

When the test cell was charged (when the graphite powder is doped with lithium), the charging process was started under the conditions of constant current of 1 mA and constant voltage of 0 mV (Li/Li+) per test cell and continued until a charging current reached 0 A. When the test cell was discharged (when the graphite powder was dedoped from lithium), the discharging process was carried out under the conditions of constant current of 1 mA per test cell and continued until terminal voltage reached 1.5 V. Then, the discharging capacity of the graphite powder/per g was calculated in terms of the discharging capacity obtained by the charging and discharging processes of the test cell under the above-described conditions.

Further, the discharging capacity was subtracted from a charging capacity to obtain the capacity loss. Even when any carbonaceous material was employed, the discharging capacity has a smaller value than that of the charging capacity during initial charging and discharging processes. This phenomenon arises, because the carbonaceous material ordinarily has a quantity of electricity that is not discharged even when the material is charged. Here, an electric capacity with which the graphite powder was charged and was not discharged was defined as the capacity loss for convenience sake. The value of the capacity loss is also important to evaluate the graphite powder.

Further, a ratio of an initial discharging capacity relative to an initial charging capacity in the test cell was defined as the charging and discharging efficiency.

<Method for Evaluating Battery Capacity and Load Characteristics at Low Temperature>

Further, the battery of each Sample was used to evaluate a capacity and load characteristics at low temperature. A constant-current and constant-voltage charging operation in which a potential area has charging voltage up to 4.2 V and a charging current value of 1000 mA was carried out relative to each Sample. After the charging operation, a constant-current discharging operation having a discharging current value of 1000 mA and discharging voltage up to 3 V was carried out to define the value of the initial discharging capacity as a battery capacity. Further, the load characteristics at low temperature were evaluated in such a way that a constant-current discharging operation having a discharging current value of 5 A and discharging voltage up to 3 V was carried out under an environment of 0° C. to each Sample charged under the above-described conditions, and a minimum value of the fall of voltage immediately after the discharging operation was measured.

The evaluated results of the characteristics of the graphite and batteries of the Sample 1 to Sample 19 are shown in Table 1.

TABLE 1

| | Graphite Powder | | | | | | | | | | Load |
|---|---|---|---|---|---|---|---|---|---|---|---|
| | | | True | | Graphite Powder | | | | Charging and | | Characteristics |
| | | Surface | Specific | | Sintering | | Discharging | | Discharging | Battery | at Low |
| | Density | Resistance | Gravity | | Temperature | Quantity Of | Capacity | Loss | Efficiency | Capacity | Temperature |
| | (g/cm³) | (Ω/cm) | (g/cm³) | Gs | (° C.) | Lime Pitch | (mAh/g) | (mAh/g) | (%) | (mAh/g) | (V) |
| Sample 1 | 1.567 | 62.4 | 2.192 | 6.2 | 2800 | 1.0 | 310 | 18.0 | 94.5 | 1700 | 2.88 |
| Sample 2 | 1.588 | 61.2 | 2.207 | 6.2 | 2850 | 1.0 | 319 | 20.0 | 94.1 | 1745 | 2.91 |
| Sample 3 | 1.612 | 59.4 | 2.228 | 6.2 | 2900 | 1.0 | 333 | 30.0 | 91.7 | 1759 | 3.03 |
| Sample 4 | 1.702 | 49.5 | 2.246 | 6.3 | 2950 | 1.0 | 345 | 19.0 | 94.8 | 1899 | 3.15 |
| Sample 5 | 1.850 | 40.3 | 2.248 | 6.2 | 3000 | 1.0 | 355 | 16.0 | 95.7 | 1974 | 3.18 |
| Sample 6 | 2.060 | 19.2 | 2.251 | 6.3 | 3050 | 1.0 | 360 | 15.0 | 96.0 | 2008 | 3.24 |
| Sample 7 | 2.216 | 15.1 | 2.255 | 6.3 | 3100 | 1.0 | 363 | 21.0 | 94.5 | 1988 | 3.29 |
| Sample 8 | 2.234 | 12.6 | 2.256 | 6.2 | 3150 | 1.0 | 365 | 27.0 | 93.1 | 1973 | 3.18 |
| Sample 9 | 2.250 | 9.7 | 2.258 | 6.2 | 3200 | 1.0 | 367 | 32.0 | 92.0 | 1955 | 3.02 |
| Sample 10 | 1.701 | 49.6 | 2.237 | 2.2 | 3000 | 3.0 | 335 | 10.0 | 97.1 | 1892 | 3.10 |
| Sample 11 | 1.770 | 46.2 | 2.241 | 3.0 | 3000 | 2.0 | 340 | 11.0 | 96.9 | 1916 | 3.14 |
| Sample 12 | 1.820 | 43.2 | 2.243 | 5.1 | 3000 | 1.6 | 342 | 13.5 | 96.2 | 1913 | 3.15 |
| Sample 13 | 1.852 | 41.8 | 2.245 | 5.9 | 3000 | 1.3 | 345 | 16.0 | 95.6 | 1916 | 3.17 |
| Sample 14 | 1.880 | 35.0 | 2.249 | 8.3 | 3000 | 0.8 | 356 | 17.0 | 95.4 | 1974 | 3.24 |
| Sample 15 | 1.910 | 28.2 | 2.250 | 9.4 | 3000 | 0.5 | 358 | 22.0 | 94.2 | 1957 | 3.26 |
| Sample 16 | 1.950 | 19.9 | 2.251 | 11.2 | 3000 | 0.3 | 359 | 31.5 | 91.9 | 1907 | 3.26 |
| Sample 17 | 1.980 | 15.3 | 2.253 | 12.1 | 3000 | 0.2 | 363 | 36.0 | 91.0 | 1904 | 3.00 |
| Sample 18 | 2.010 | 11.2 | 2.254 | 20.0 | 3000 | 0.1 | 366 | 40.0 | 90.1 | 1898 | 3.05 |
| Sample 19 | 2.100 | 8.8 | 2.256 | 22.3 | 3000 | 0 | 368 | 55.0 | 87.0 | 1823 | 2.97 |

Firstly, from the evaluated results shown in the Table 1, the Gs values of the graphite are examined. In the Sample 19 in which the Gs value is larger than 20, the capacity loss is increased and the charging and discharging efficiency is decreased. Thus, it is obvious that the adequate battery capacity and load characteristics at low temperature can not be obtained. In other Samples that the Gs values are not larger than 20, it is obvious that the Sample 10 in which the Gs value is smaller than 3 has a low discharging capacity and does not obtain an adequate battery capacity. Further, in the Sample 16 to the Sample 18 in which the Gs values are larger than 10, it is recognized that the capacity loss is increased, the charging and discharging efficiency is low and the adequate battery capacity is not obtained.

Further, when the density of a pellet is examined, in the Sample 1 to the Sample 3 in which the density of the pellet is lower than 1.7 g/cm³, contact points between the particles are not adequately ensured and the surface resistance is undesirably high. Accordingly, it is recognized that the charging and discharging efficiency is low and the adequate battery capacity and load characteristics at low temperature are not obtained. On the other hand, in the Sample 9 in which the density of the pellet is 2.250 g/cm³, it is recognized that the capacity loss is increased and the charging and discharging efficiency is decreased.

Further, when the surface resistance of the pellet is examined, in the Sample 1 to the Sample 3 in which the surface resistance is higher than 50 Ω/cm, it is obvious that the capacity loss is increased, the charging and discharging efficiency is low and the adequate battery capacity and load characteristics at low temperature are not obtained.

Still further, when the true specific gravity of the graphite is examined, in the Sample 1 in which the specific gravity is lower than 2.2 g/cm³, it is recognized that the battery capacity and the load characteristics at low temperature are not adequately obtained.

As compared with these Samples, in the Sample 4 to the Sample 8 and the Sample 11 to the Sample 15 in which the Gs values are not higher than 20 and are preferably located within a range of 3 or higher and 10 and lower, the density of the pellet is located within a range of 1.7 g/cm³ or higher and 2.25 g/cm³ or lower, the surface resistance is 50 Ω/cm and lower and the true specific gravity is located within a range of 2.24 g/cm³ or higher and 2.256 g/cm³ or lower, it is recognized that the capacity loss is suppressed to small values, and the discharging capacity, the charging and discharging efficiency, the battery capacity and the load characteristics at low temperature are improved, and good results can be obtained in all these characteristics.

From the above-described results, the Gs value of the graphite particles are set to 20 or lower, and specifically set to a range of 3 or higher and 10 or lower, it is recognized that the high reversible capacity and load characteristics can be achieved. Further, the density of the pellet of the graphite particles is set to 1.70 g/cm³ or higher, the surface resistance is 50 Ω/cm or lower and the true specific gravity is set to 2.20 g/cm³ or higher so that the higher reversible capacity and the load characteristics can be achieved.

As described above, according to the present invention, the parameters of the graphite serving as the anode active material are specified so that the irreversible capacity during the initial charging operation can be greatly reduced and the high reversible capacity can be realized. Thus, in the present invention, the non-aqueous electrolyte battery that can exhibit the high discharging capacity and is excellent in its load characteristics at low temperature can be realized.

While the invention has been described in accordance with certain preferred embodiments thereof illustrated in the accompanying drawings and described in the above description in detail, it should be understood by those ordinarily skilled in the art that the invention is not limited to the embodiments, but various modifications, alternative constructions or equivalents can be implemented without departing from the scope and spirit of the present invention as set forth and defined by the appended claims.

1. A non-aqueous electrolyte battery comprising:
a cathode;
an anode; and
a non-aqueous electrolyte, wherein the anode uses as an anode active material graphite whose Gs value obtained by a formula (1) from a surface-enhanced Raman spectrum measured by using an argon laser beam is 20 or smaller
Gs=Hsg/Hsd (1)
(Here, Hsg represents the height of a signal having a peak within a range of 1580 cm⁻¹ to 1620 cm⁻¹ and Hsd represents the height of a signal having a peak within a range of 1350 cm⁻¹ to 1400 cm⁻¹.)

2. The non-aqueous electrolyte battery according to claim 1, wherein the Gs value of graphite is located within a range of 3 or larger and 10 or smaller.

3. The non-aqueous electrolyte battery according to claim 1, wherein the true specific gravity of graphite is 2.20 g/cm³ or higher.

4. The non-aqueous electrolyte battery according to claim 1, wherein in the graphite, the graphite of a sample of 0.25 g is weighed into a pellet making device having a diameter of 13 mm and pressurized under 5 tf/cm² so that a formed pellet has a density of 1.70 g/cm³ or higher.

5. The non-aqueous electrolyte battery according to claim 1, wherein in the graphite, the graphite of a sample of 0.25 g is weighed into a pellet making device having a diameter of 13 mm and pressurized under 5 tf/cm² so that the surface resistance of a formed pellet is 50 Ω/cm or lower.
